(19) United States
(12) Patent Application Publication
(10) Pub. No.: US 2012/0331384 A1
(43) Pub. Date: Dec. 27, 2012

(54) DETERMINING AN OPTION BASED ON A REACTION TO VISUAL MEDIA CONTENT

(76) Inventors: Tanvir Islam, Ft. Collins, CO (US); Jason Yost, Windsor, CO (US); Shane D Voss, Fort Collins, CO (US)

(21) Appl. No.: 13/165,076

(22) Filed: Jun. 21, 2011

(51) Int. Cl. G06F 3/01

(52) U.S. Cl. 715/716

(57) ABSTRACT

Implementations disclosed herein relate to determining an option based on a reaction to visual media content. In one implementation, a processor determines a user's degree of preference for visual media content and selects an option based on the determined degree of preference. The processor may provide the determined degree of preference.

### BACKGROUND

Electronic devices may be used to capture visual media content. For example, a mobile phone may include capabilities for capturing photographs and videos. Many options may be available for the captured visual media content. For example, a mobile phone may capture an image that may then be stored, edited, or shared.

### BRIEF DESCRIPTION OF THE DRAWINGS

The drawings describe example implementations. The drawings show methods performed in an example order, but the methods may also be performed in other orders. The following detailed description references the drawings, wherein:

FIG. 1 is a block diagram illustrating one example of an electronic device.

FIG. 2 is a block diagram illustrating one example of a computing system.

FIG. 3 is a block diagram illustrating one example of a computing system.

FIG. 4 is a flow chart illustrating one example of a method to determine an option based on a reaction to visual media content.

FIG. 5 is a diagram illustrating one example of a table to map a degree of preference for visual media content to a visual media content option.

FIG. 6 is a diagram illustrating one example of an image analyzed by a user.

FIG. 7 is a diagram illustrating one example of detecting the reaction of multiple users to visual media content.

### DETAILED DESCRIPTION

A user may have several options for using visual media content. For example, a user may erase, share, edit, or store an image. To help a user navigate among the many options, an electronic device may automatically determine an option for using visual media content based on a user's reaction to the visual media content. For example, the electronic device may determine a user's degree of preference for a still or video image based on the user's visual, audio, or movement characteristics in response to viewing the image. The electronic device may then select an option for the image based on the degree of preference. For example, visual media content that is strongly liked may be shared, and visual media content that is strongly disliked may be erased. Determining a user's reaction automatically without a user selecting a degree of preference for the visual media content may provide a better user experience. In some cases, the electronic device may present the determined option to the user for the user to accept or reject. The electronic device may in some implementations automatically perform the option, thereby saving the user time.

As an example, a user may capture an image on a mobile phone and then view the image. The mobile phone may take a picture of the user viewing the image and determine the user's degree of preference for the viewed image based on characteristics of the image captured of the user. The mobile phone may then present options for the viewed image that are selected based on the user's degree of preference for the viewed image. If the user accepts the suggested option, the mobile phone may perform it or send it to another electronic device to perform it. For example, the mobile phone may delete the image or transmit it to a social networking website for sharing.

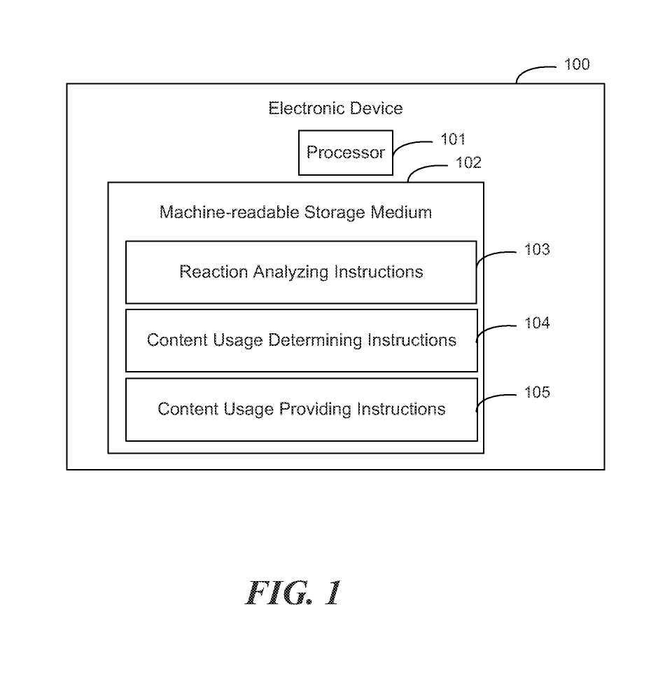

FIG. 1 is a block diagram illustrating one example of an electronic device 100. The electronic device 100 may be used, for example, to determine a user's degree of preference for visual media content based on a user's reaction to the visual media content and to determine an option for the visual media content based on the user's degree of preference. The electronic device 100 may be a desktop, laptop, or mobile computing device. In some implementations, the electronic device 100 is a server for communicating with a user electronic device via a network. The electronic device 100 may include a processor 101 and a machine-readable storage medium 102.

The processor 101 may be any suitable processor, such as a central processing unit (CPU), a semiconductor-based microprocessor, or any other device suitable for retrieval and execution of instructions. In one implementation, the electronic device 100 includes logic instead of or in addition to the processor 101. As an alternative or in addition to fetching, decoding, and executing instructions, the processor 101 may include one or more integrated circuits (ICs) (e.g., an application specific integrated circuit (ASIC)) or other electronic circuits that comprise a plurality of electronic components for performing the functionality described below. In one implementation, the electronic device 100 includes multiple processors. For example, one processor may perform some functionality and another processor may perform other functionality described below.

The machine-readable storage medium 102 may be any suitable machine-readable storage medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 101.

The machine-readable storage medium 102 may include reaction analyzing instructions 103, content usage determining instructions 104, and content usage providing instructions 105. The reaction analyzing instructions 103 may include instructions for analyzing a user's reaction to viewing visual media content to determine the user's degree of preference for the visual media content. For example, a user's visual, audio, or movement characteristics may be analyzed. The visual media content may be any suitable visual media content, such as a still picture, video, text message, or email message.

The content usage determining instructions 104 may include instructions for determining an option for using the visual media content based on the user's degree of preference for the visual media content. For example, the electronic device 100 may access a table, such as table within the electronic device 100 or available via a network. The table may map a degree of preference to an option for using visual media content. In some cases, the usage option may depend on the type of visual media content analyzed, such as whether the visual media content is an image or a text message. The usage option may be, for example, to store, edit, erase, or share the visual media content.

The content usage providing instructions 105 may include instructions for providing the determined option. For example, the option may be stored, transmitted, or displayed. The electronic device 100 may perform or help perform the determined image option. In one implementation, the option is provided to a user to accept or reject. In some cases, multiple options may be presented to the user, and the user may select one of the presented options.

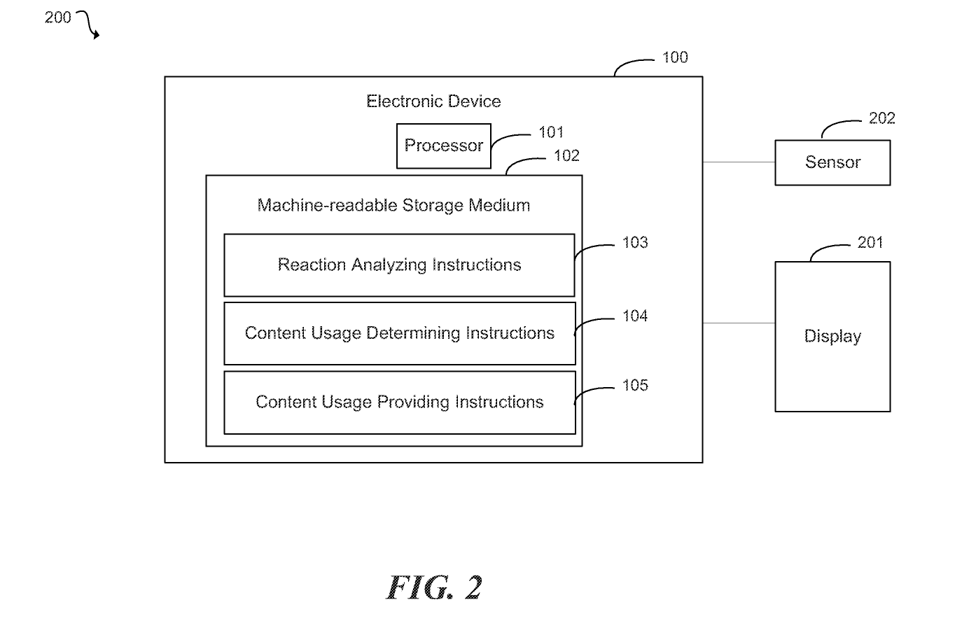

FIG. 2 is a block diagram illustrating one example of a computing system 200. The computing system 200 includes the electronic device 100 where the electronic device has an associated display 201 and sensor 202. The display 201 may be a display within or communicating with the electronic device 100. For example, the display 201 may be a screen on a mobile phone, or a monitor communicating with a desktop computer. The display 201 may display visual media content. For example, the display 201 may display a still image, a video, a text message, or word processing document to a user. In some cases, the displayed visual media content may be captured by the electronic device 100. For example, the electronic device 100 may include a camera for capturing an image displayed on the display 201. In some cases, the user may receive the visual media content from another source such that it is not captured by the electronic device 100.

The sensor 202 may be a sensor for sensing the reaction of a person to the visual media content displayed on the display 201. The sensor 202 may be, for example, a camera, video camera, accelerometer, or microphone. For example, the electronic device 100 may be a mobile phone, and the sensor 202 may be an accelerometer within the mobile phone. As another example, the electronic device 100 may be a laptop computer with a webcam included in the display bezel. The sensor 202 may be used to sense a user's visual, audio, or movement response to viewing the visual media content. The user's reaction may be analyzed, for example, by the processor 101 executing the instructions stored in the machine-readable storage medium 102.

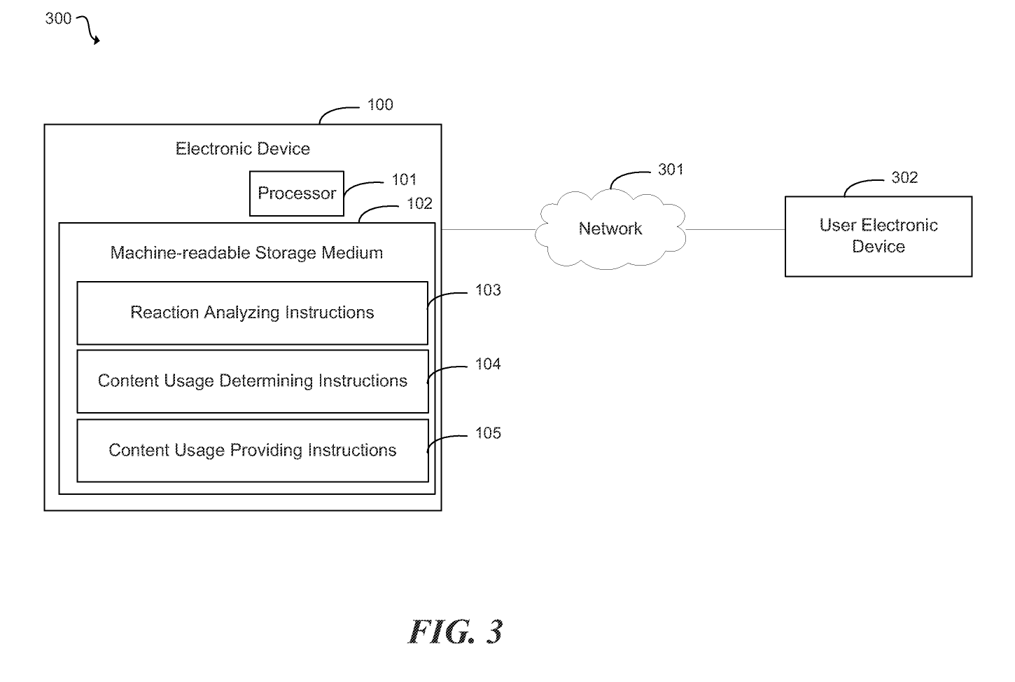

FIG. 3 is a block diagram illustrating one example of a computing system 300. The computing system 300 includes the electronic device 100 from FIG. 1, a network 301, and a user electronic device 302. The network 301 may be, for example, the Internet, and the user electronic device 302 may be, for example, a mobile phone, mobile computing device, or personal computer. In one implementation, the electronic device 100 determines a user's reaction to visual media content and selects an option as a network based service. For example, the user electronic device 302 may capture an image of a user reacting to a viewed image. The captured image of the user may be sent to the electronic device 100 via the network 301 for analysis. The electronic device 100 may determine the user's degree of preference and an option for using the image. The option may be transmitted back to the user electronic device 302 via the network 301. In some cases, the user may accept the option, and the electronic device 100 may perform it. In one implementation, the computing system 300 may be used in a social networking context. For example, a user may upload visual media content to the user's social networking account, and the reaction of user uploading the image and other user's may be used to determine a usage option for the uploaded visual media content.

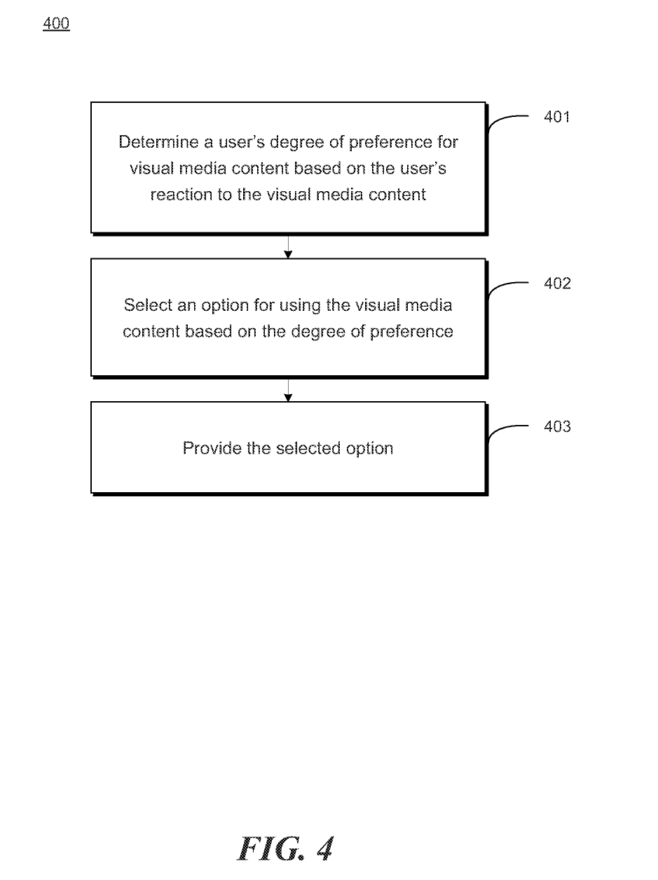

FIG. 4 is a flow chart illustrating one example of a method to determine an option based on a reaction to visual media content. For example, a user's degree of preference for the visual media content may be determined based on the user's reaction when viewing the visual media content. Determining a user's degree of preference for visual media content using an automated detection of a user's reaction may be more user friendly than having a user manually enter his degree of preference for the visual media content. A usage option for using the visual media content may be selected based on the degree of preference. For example, more preferred images may be associated with an option to share the image with more people. The option may be provided, such as displayed, transmitted, or stored. In some cases, the processor may execute the determined option. The method may be implemented, for example, by the electronic device 100.

Beginning at 401, a processor determines a user's degree of preference for visual media content based on the user's reaction to the visual media content. The processor may be any suitable processor, such as the processor 101. The degree of preference may be determined based on any suitable reaction of the user, such as visual, audible, or movement related reactions. The processor may receive information from a sensor for sensing the user reaction. The sensor may be associated with the same electronic device as the processor, or the processor may receive information about a user's reaction from another electronic device via a network. In some cases, the processor may retrieve information about a user's reaction from a storage medium accessible to the electronic device. For example, the user's reaction may be recorded and stored for later analysis.

The user reaction may be determined in any suitable manner. In one implementation, the degree of preference is determined based on an image of the user viewing the visual media content. The features of the user in the image, such as the eyes or mouth may be analyzed to determine the user's level of like or dislike for the image. The user reaction may determined based on information from an accelerometer. For example, information indicating that a user held a portable display device still to examine the visual media content may indicate that the user found the visual media content more preferable. In some implementations, an audio reaction may be analyzed. Voice recognition software may analyze information from a microphone on the electronic device. For example, a user making a comment may be analyzed to determine whether it is a more positive or negative comment.

The user's reaction may be determined at any suitable time. For example, the user's reaction may be determined as a user immediately reviews visual media content, such as reviewing a picture that was captured minutes before. In some cases, the user may review visual media content captured or received at a time period prior to the review, such as a user returning from vacation and reviewing the images taken.

The degree of preference may be on any scale of degree of preference. For example, a user's reaction may be categorized in a scale of three levels or five levels of preference. In some cases, the processor may categorize the reaction on a two level scale, such as where a user is determined to like or dislike the visual media content.

In one implementation, the processor determines who had the reaction to the visual media content. For example, the owner of a mobile phone may have one reaction to an image viewed on the mobile phone, and a friend seeing the image on the mobile phone may have a different reaction. The processor may limit its analysis to a particular user, or may alter the determined option based on which user had the particular reaction.

Moving to 402, the processor selects an option for using the visual media content based on the degree of preference. The option may be, for example, to share, edit, erase, or store the image. In some cases, the processor looks up the determined degree of preference in a storage that maps a degree of preference to an option. For example, the processor may categorize a user's reaction on a scale of 1 to 5 where degree of preference level 1 is mapped to a particular option and degree of preference level 2 is mapped to a different option. The processor may determine options for one type of visual media content or for multiple types of visual media content. In some cases, the option may be based on the type of visual media content. In some implementations, the processor determines multiple options for the visual media content and allows a user to select one of the determined options.

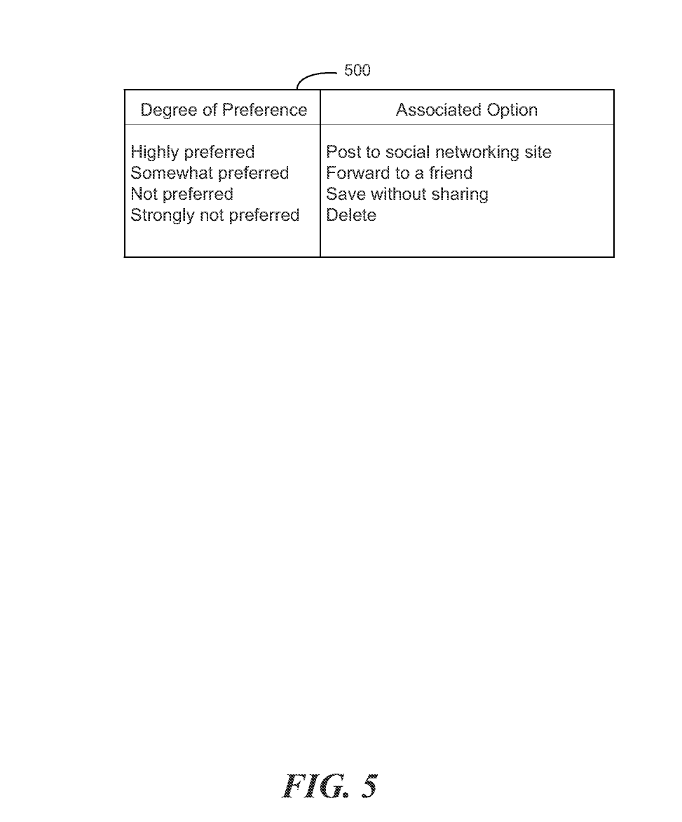

FIG. 5 is a diagram illustrating one example of a table 500 to map a degree of preference for an image to an image option. For example, a highly preferred image may be posted on a social networking site, a somewhat preferred image may be forwarded to a friend, a not preferred image may be saved without sharing, and a strongly not preferred image may be erased. In one implementation, the associated option may be presented to a user for a user to accept or reject. In another implementation, the associated option may be executed without user approval.

The option may be determined based on additional factors, such as who had the particular degree of preference, the timing of the determined degree of preference, or the relationship of the user to the visual media content. For example, a user featured in the visual media content, such as where the user is in an image, may be analyzed differently than where the user is not featured in the visual media content. As another example, a degree of preference when viewing an image immediately after it is captured may be paired with an option differently than where the degree of preference is associated with a later viewing of the image.

In one implementation, the options are adjusted based on the user. For example, the user's rate of accepting an option associated with a level of preference may be used to update the mapping. As an example, if the processor asks for confirmation to post a preferred image on a social networking website, and the user repeatedly rejects, the processor may update the option table such that posting a video on a social networking website is no longer an option within the mapping. The processor could use, for example, automatic learning techniques to determine whether an option is likely to be of interest to a user. In some implementations, a user may provide input as to the type of desired options. For example, a user may enter information in a user interface that indicates that a user does not want an option to post videos on a social networking website.

Referring back to FIG. 4 and proceeding to 403, the processor provides the selected option. For example, the processor may store, transmit, or display the selected option. The processor may transmit the selected option to another electronic device to perform further processing or to perform the option. The processor may store the selected option to perform or transmit at a later time.

In one implementation, the processor causes the selected option to be displayed for a user to review. The processor may request confirmation for the selected option. For example, the processor may cause the option to be displayed such that a user may accept or reject it. In some cases, multiple options may be presented to a user associated with a particular degree of preference, and the user may select one of the presented options.

In some implementations, the processor executes the determined option. For example, the processor may erase, or store the visual media content. The processor may transmit the visual media content or information about the option associated with the visual media content to another electronic device for performing the option. For example, the processor may transmit the visual media content to share it, such as by automatically sending an image in an email or Short Message Service message or by uploading the image to a social networking account.

In one implementation, the option may be to edit the visual media content in a particular way. The processor may perform the edit and the process may start over with detecting the user's reaction to the edited visual media content. In some cases, the option may be a type of edit or a particular portion of the visual media content to edit. For example, the processor may determine which portion of the visual media content to the user is reacting to and provide an option for that portion. The processor may determine the portion to edit or the type of edit based on the user reaction. For example, a user that squints at the visual media content or appears to have eye strain to view a particular portion of the visual media content may indicate that the lighting is bad for the particular portion of an image or that a font is too small for a word processing document.

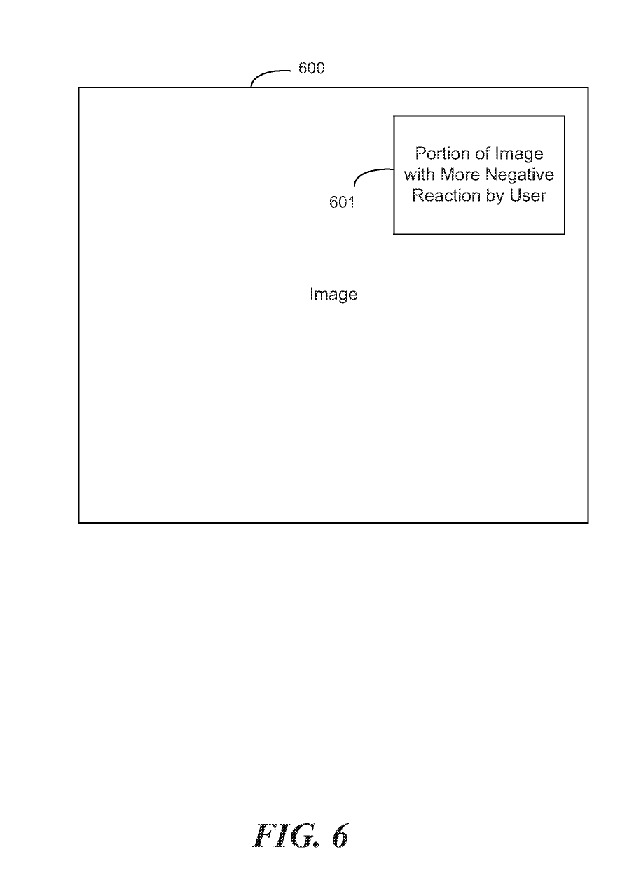

FIG. 6 is a diagram illustrating one example of an image 600 analyzed by a user. In one implementation, a processor may determine a user's reaction to a portion of visual media content, and provide an option for adjusting the particular portion. The image 600 includes a portion 601 that is associated with a more negative reaction from a user. A processor may determine that a user was focusing on the portion 601 and determine that the degree of preference is low. As a result, the processor may present options to edit the portion, such as to crop the portion 601 or to change the light in the portion 601.

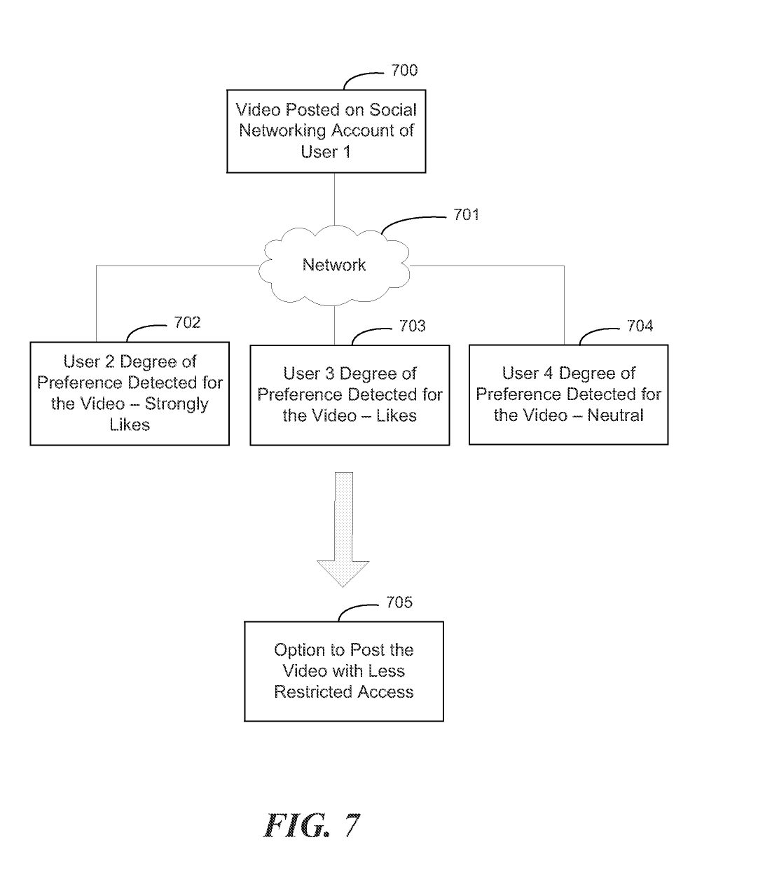

FIG. 7 is a diagram illustrating one example of detecting the reaction of multiple users to visual media content. For example, in some implementations, a processor may analyze the reaction of multiple users to visual media content posted on a website, such as a social networking website. Options may be provided to the user posting the content or to users viewing the content. The options may be based on the reaction and the user associated with the reaction. For example, a user marked with a special status or a person in the visual media content may lead to one type of option and the reaction of other users may lead to another type of option. As an example, if a user shown in a video has a favorable reaction, the user may be tagged or linked to the video. In some cases, the reactions may be aggregated. For example, visual media content may be shared more widely if more users had a more favorable reaction to it. The electronic devices of the individual users may capture information about the users' reactions and send the information to a processor via a network to analyze.

FIG. 7 shows a video 700 posted on a social networking website. For example, the video may be associated with an account of a user 1. Block 702 shows that a user 2 strongly likes the video 700. For example, a sensor on user 2's computer may capture user 2's reaction to viewing the video, and send it via a network 701 to a processor associated with the social networking site. The processor may determine based on the reaction that user 2 strongly likes the video 700. Block 703 shows that a user 3 likes the video 700, and block 704 shows that a user 4 has a neutral feeling the video 700. Block 705 shows that based on the reactions of user 2, user 3, and user 4, a processor determined that an option to post the video 700 with less restricted access was selected. For example, because the video got mostly favorable responses, an option may be selected to post the video 700 on a website that shares content without permissions restrictions for viewing.

Providing visual media content options based on a user reaction may create a more user friendly experience for managing visual media content. A user may naturally react to the visual media content without providing explicit user input about the user's preference for the visual media content or input about a usage option.

1. A method, comprising:
determining, by a processor, a user's degree of preference for visual media content based on the user's reaction to the visual media content;
selecting an option for using the visual media content based on the degree of preference; and
providing the selected option.

2. The method of claim 1, wherein determining a user's degree of preference for visual media content comprises determining a user's degree of preference for a portion of the visual media content and wherein selecting an option comprises selecting an option for the portion of the visual media content.

3. The method of claim 1, wherein determining the user reaction comprises analyzing at least one of visual, audio, or movement characteristics of the user reviewing the visual media content.

4. The method of claim 1, further comprising receiving via a network information about the user's reaction to the visual media content.

5. The method of claim 1, wherein selecting an option for the visual media content based on the degree of preference comprises:
presenting multiple options for the visual media content to the user based on the degree of preference; and
selecting at least one of the presented options based on user input.

6. A machine-readable non-transitory storage medium comprising instructions executable by a processor to:
analyze a user's reaction to visual media content to determine a user's degree of preference for the visual media content;
determine a usage option for the visual media content based on the user's degree of preference; and
provide the determined option.

7. The machine-readable non-transitory storage medium of claim 6, further comprising instructions to perform the provided option.

8. The machine-readable non-transitory storage medium of claim 6, wherein analyzing user's reaction comprises analyzing at least one of: visual, audio, or movement characteristics of the user.

9. The machine-readable non-transitory storage medium of claim 6, wherein analyzing a user's reaction to visual media content comprises determining a user's reaction to a portion of the visual media content, and wherein determining a usage option comprises determining an editing option for the portion of the visual media content.

10. The machine-readable non-transitory storage medium of claim 6, further comprising instructions to store information about a user's past selections of options, wherein instructions to determine a usage option is further based on the user's past selections of image options.

11. An electronic device, comprising
a processor to:
analyze captured data related to a user's reaction to visual media content to determine a degree of preference for the viewed visual media content;
determine an option for using the visual media content based on the analysis; and
provide the determined option.

12. The electronic device of claim 11, wherein the captured data related to a user's reaction is captured by at least one of: a microphone, camera, or accelerometer.

13. The electronic device of claim 11, wherein the visual media content comprises at least one of: a still image, a video image, an electronic document, or an electronic message.

14. The electronic device of claim 11, further comprising displaying on the display the determined option and receiving feedback related to the determined option.

15. The electronic device of claim 11, further comprising a storage for mapping degrees of preference to options.
